(19) United States
(12) Patent Application Publication
(10) Pub. No.: US 2002/0044117 A1
(43) Pub. Date: Apr. 18, 2002

(54) Liquid crystal display device

(76) Inventors: Tatsuya Matsumura, Kumamoto (JP); Susumu Shibata, Kumamoto (JP)

Correspondence Address: MCDERMOTT WILL & EMERY, 600 13TH STREET, N.W., WASHINGTON, DC, 20005-3096, US

(21) Appl. No.: 09/935,043

(22) Filed: Aug. 23, 2001

(30) Foreign Application Priority Data
Aug. 24, 2000 (JP) P2000-253829

(51) Int. Cl. G09G 3/36

(52) U.S. Cl. 345/87

(57) ABSTRACT

A liquid crystal display device which can reduce the persistence of vision is provided. All gate lines are divided into a plurality of blocks and then an image data writing operation which selects respective gate lines for image display and supplies image data signals corresponding to respective gate lines to source lines and a non-image data writing operation which simultaneously selects all gate lines for each block and supplies non-image data signals to the source lines are performed. In the signal processing of the gate lines, immediately before the image data writing operation of the preceding block, the non-image data writing processing is selected, and in the signal processing of the source lines, the image data signals are cumulatively delayed by an amount corresponding to the non-image data signal insertion period for every block during one frame period or during one field period.

### BACKGROUND OF THE INVENTION

1. Field of the Invention

The present invention relates to a liquid crystal display device which uses liquid crystal.

2. Description of the Related Art

FIG. 11 is a constitutional view of a conventional display device using liquid crystal. In the drawing, numeral 1 indicates a display screen of a liquid crystal panel or the like, numeral 2 indicates a gate line drive circuit such as a scanning line drive circuit or the like, numeral 3 indicates a source line drive circuit such as a signal line drive circuit or the like, numeral 4 indicates a control circuit which is served for generating input signals to the gate line drive circuit 2 and the source line drive circuit 3, and numeral 5 indicates a power supply part which generates reference voltages of a circuit system.

In an electric circuit constitution of the display device, the input signals from the outside (input signals to the control circuit 4) include clock input signals, image data input signals, data enable input signals and other control input signals (for example, horizontal synchronizing input signals, vertical synchronizing input signals and the like). Here, the data enable input signal means a signal which designates an effective data period of the image data input signal with respect to the time axis. The data enable input signal usually exhibits a voltage level of high level H during the effective data period and a voltage level of low level L other than the effective data period.

FIG. 12(a) to FIG. 12(d) are voltage waveform diagrams of four signals which are inputted to the control circuit 4 for every horizontal cycle. In respective drawings, the same elapsed time is taken on the abscissa. FIG. 12(a) indicates the waveform of the horizontal synchronizing input signal 6, FIG. 12(b) indicates the waveform of the data enable input signal 7, FIG. 12(c) indicates the waveform of the clock input signal 8 and FIG. 12(d) indicates the waveform of the image data input signal 9. In FIG. 12(b), numeral 10 indicates the effective data period of the image data input signal 9. In FIG. 12(c), 1CLK indicates one cycle of the clock input signal 8. In FIG. 12(a), 1H indicates a cycle of the horizontal synchronizing input signal 6. In FIG. 12(c), an arrow of an edge of the clock input signal 8 indicates an active edge (rising edge in the drawing) of the clock input signal 8. In FIG. 12(d), a blank portion of the image data input signal 9 indicates the effective data period and a hatched portion of the image data input signal 9 indicates the ineffective data period and m indicates the screen size (resolution) in the horizontal direction. Here, with respect to the horizontal synchronizing input signal 6 in FIG. 12(a), it is assumed that the voltage of the low level L indicates a reset period, that is, a period in which the effective data period is not present.

FIG. 13(a) to FIG. 13(c) are voltage waveform diagrams of three signals which are inputted to the control circuit 4 for every vertical cycle. In respective drawings, the same elapsed time is taken on the abscissas. FIG. 13(a) indicates the waveform of the vertical synchronizing input signal 11, FIG. 13(b) indicates the waveform of the horizontal synchronizing input signal 6, and FIG. 13(c) indicates the waveform of the image data input signal 9. 1H in FIG. 13(b) indicates one cycle of the horizontal synchronizing input signal 6 and 1 V in FIG. 13(a) indicates one cycle (frame cycle or field cycle) of the vertical synchronizing input signal 11. In FIG. 13(c), a blank portion of the image data input signal 9 indicates the effective data period and a hatched portion of the image data input signal 9 indicates the ineffective data period and n indicates the screen size (resolution) in the vertical direction. Here, with respect to the vertical synchronizing input signal 11, it is assumed that the voltage level of the low level L indicates a reset period, that is, a period in which the effective period is not present.

Further, the control circuit 4 generates clock signals and data signals other than the clock signals as the output signals which are used as the input signals to a driver IC or drive circuits, that is, the gate line drive circuit 2 and the source line drive circuit 3 which generate signals for driving the display screen 1. Here, the clock signals mean clock signals (a vertical clock output signal in the gate line drive circuit 2 and a horizontal clock output signal in the source line drive circuit 3) which are respectively used in the gate line drive circuit 2 and the source line drive circuit 3. The data signals other than the clock signals mean the image data signals (the horizontal image data output signals) and other control signals other than the image data signals (for example, the horizontal start output signals, the vertical start output signals, the horizontal latch output signals, the horizontal drive voltage polarity control output signals and the like).

FIG. 14 is a constitutional view of the display screen 1. In the drawing, numeral 12 indicates source lines for transmitting signals generated by the source line drive circuit 3, numeral 13 indicates gate lines for transmitting signals generated by the gate line drive circuit 2, numeral 14 indicates display elements such as liquid crystal, numeral 15 indicates switching elements, numeral 16 indicates capacitor elements, wherein a pixel cell is constituted of the display element 14, the switching element 15 and the capacitor element 16.

FIG. 15 is a voltage waveform diagram (timing chart) of voltages inputted to the source lines 12 and the gate lines 13 on the display screen 1 for every vertical cycle. In the drawing, numerals 1, 2, 3 . . . m of X1 indicates 1H cycles and each 1H cycle includes image data in the period 10 shown in FIG. 12. Y1, Y2, Y3, . . . indicate gate pulses applied to respective gate lines 13 and suffix numbers given to Y correspond to 1, 2, 3, . . . A3, A3+1, . . . which are described in the vertical effective data period 17 and correspond to the gate line numbers. 1Hs which are indicated by respective numerals X1 to Xm are in synchronism with pulses which are indicated by numerals Y1, Y2, Y3, . . . YA3, YA3+1, . . . . Here, the gate line numbers correspond to 1 to n shown in FIG. 13. Further, to enable the comparison between FIG. 1 and FIG. 2 which show the embodiment of the present invention, in FIG. 15, the timing chart is expressed by dividing into blocks in the same manner as FIG. 1 and FIG. 2.

During one frame cycle or during one field cycle, the gate lines Y1, Y2, Y3, . . . YA3, YA3+1 . . . in FIG. 14 and FIG. 15 are risen in sequence to write the image data signals in pixel cells in the display screen so that a writing effective period 17 is provided (state of high level H in the drawing). During the period 17, when the gate line is in the state of high level H, the switching element 15 becomes the ON state and the electric charge corresponding to the image data signal is charged into the capacitor element 16. When the gate line is in the state of low level L, the switching element 15 becomes the OFF state and the display element 14 responds corresponding to the electric charge which is charged to the capacitor element 16 and displays the image on the display screen 1. When all gate lines from the first line to the last line are risen so as to write the image data signals in the pixel cells, 1 frame cycle is completed.

The time that the liquid crystal display element 14 of the pixel cell which is used in the display screen 1 requires from the response start to the response completion in the response characteristics is usually larger than the 1 frame period or the 1 field period and hence, particularly in the case of moving images whose change of image is frequent, the response moves to a next response before the preceding response is not completed yet thus giving rise to a problem that the persistence of vision is generated.

Accordingly, it is an object of the present invention to provide a liquid crystal display device which can solve the above-mentioned drawback and can realize the reduction of the persistence of vision.

### SUMMARY OF THE INVENTION

According to a first aspect of the present invention, there is provided a liquid crystal display device which comprises a plurality of gate lines, a plurality of source lines which intersect a plurality of respective gate lines, and a plurality of pixel cells which are arranged in a matrix array corresponding to intersecting points of said gate lines and said source lines, wherein the improvement is characterized in that a plurality of gate lines are divided into a plurality of gate line blocks, in the respective gate line blocks, prior to an image data writing operation for sequentially selecting the respective gate lines for an image display and for supplying image data signals corresponding to the respective gate lines to corresponding respective source lines, a non-image data writing operation for selecting all gate lines of the gate line block and for simultaneously supplying non-image data signals to corresponding respective source lines is performed.

According to a second aspect of the present invention, with respect to the liquid crystal display device of the first aspect of the invention, in a signal processing of respective source lines corresponding to a plurality of respective gate line blocks, the image data signals are sequentially supplied corresponding to respective gate line blocks, and respective image data signals corresponding to each gate line block are sequentially cumulatively delayed by an amount corresponding to a period of non-image data signals for every corresponding gate line block during one frame period.

According to a third aspect of the present invention, with respect to the liquid crystal display device of the first aspect of the invention, in a signal processing of respective source lines corresponding to a plurality of respective gate line blocks, the image data signals are sequentially supplied corresponding to respective gate line blocks, and respective image data signals corresponding to each gate line block are sequentially cumulatively delayed by an amount corresponding to a period of the non-image data signals for every corresponding gate line block during one field period.

According to a fourth aspect of the present invention, with respect to the liquid crystal display device of the first aspect of the present invention, in a signal processing of gate lines corresponding to a plurality of respective gate line blocks, immediately before performing the image data writing operation with respect to the preceding gate line block, the non-image data writing operation is performed with respect to the succeeding gate line block.

According to a fifth aspect of the present invention, with respect to the liquid crystal display device of the fourth aspect of the present invention, in a signal processing of respective source lines corresponding to a plurality of respective gate line blocks, the image data signals are sequentially supplied corresponding to respective gate line blocks, and respective image data signals corresponding to each gate line block are sequentially cumulatively delayed by an amount corresponding to a period of the non-image data signals for every corresponding gate line block during one frame period.

According to a sixth aspect of the present invention, in a liquid crystal display device of the fourth aspect of the present invention, in a signal processing of respective source lines corresponding to a plurality of respective gate line blocks, the image data signals are sequentially supplied corresponding to respective gate line blocks, and respective image data signals corresponding to each gate line block are sequentially cumulatively delayed by an amount corresponding to a period of non-image data signals for every corresponding gate line block during one field period.

According to a seventh aspect of the present invention, with respect to a liquid crystal display device of the first aspect of the present invention, in a signal processing of respective source lines corresponding to a plurality of respective gate line blocks, the image data signals are sequentially supplied corresponding to respective gate line blocks, and respective image data signals corresponding to each gate line block are sequentially cumulatively delayed by an amount corresponding to the period of non-image data signals for every corresponding gate line block during a plurality of frame periods.

According to an eighth aspect of the present invention, with respect to a liquid crystal display device of the first aspect of the present invention, in a signal processing of respective source lines corresponding to a plurality of respective gate line blocks, the image data signals are sequentially supplied corresponding to respective gate line blocks, and respective image data signals corresponding to each gate line block are sequentially cumulatively delayed by an amount corresponding to the period of non-image data signals for every corresponding gate line block during a plurality of field periods.

According to a ninth aspect of the present invention, there is provided a liquid crystal display device which comprises a plurality of gate lines, a plurality of source lines which intersect a plurality of respective gate lines, and a plurality of pixel cells which are arranged in a matrix array corresponding to intersecting points of said gate lines and said source lines, wherein the improvement is characterized in that a plurality of the gate lines are divided into a plurality of gate line blocks, respective gate line blocks are provided with corresponding gate line drive circuits, each gate line drive circuit includes drive elements which drive respective gate lines in corresponding gate line block, the respective drive elements of the gate line drive circuit which corresponds to the each gate line block are controlled such that the drive elements simultaneously and preliminarily drive the corresponding gate lines prior to driving thereof for supplying image video signals to the corresponding gate lines.

According to a tenth aspect of the present invention, there is provided a liquid crystal display device which comprises a plurality of gate lines, a plurality of source lines which intersect a plurality of respective gate lines, and a plurality of pixel cells which are arranged in a matrix array corresponding to intersecting points of said gate lines and said source lines, wherein the improvement is characterized in that a plurality of gate lines are divided into a plurality of gate line blocks, the source lines which correspond to each gate line block are provided with a source line drive circuit, the source line drive circuit is constituted such that the line drive circuit sequentially supplies image data signals corresponding to each gate line block, and respective data signals which correspond to each gate line block are sequentially cumulatively delayed by a given period.

### BRIEF DESCRIPTION OF THE DRAWINGS

FIG. 1 is a voltage waveform view of voltages of a source line and a gate line which are inputted to a display screen in a liquid crystal display device according to a first embodiment of the present invention.

FIG. 2 is a voltage waveform view of voltages which are inputted to and outputted from a gate line drive circuit in a liquid crystal display device according to a second embodiment of the present invention.

FIG. 3 is an example of a circuit constitution which constitutes a part of the gate line drive circuit in the liquid crystal display device according to the second embodiment of the present invention.

FIG. 4 is a voltage waveform view of voltages of a gate line which are inputted to a display screen in the liquid crystal display device according to the second embodiment of the present invention.

FIG. 5 is a voltage waveform view of voltages which are inputted to and outputted from a gate line drive circuit in a liquid crystal display device according to a third embodiment of the present invention.

FIG. 6 is an example of a circuit constitution which constitutes a part of the gate line drive circuit in the liquid crystal display device according to the third embodiment of the present invention.

FIG. 7 is a voltage waveform view of voltages of a gate line which are inputted to a display screen in the liquid crystal display device according to the third embodiment of the present invention.

FIG. 8 is a voltage waveform view of voltages which are inputted to and outputted from a source line drive circuit in a liquid crystal display device according to a fourth embodiment of the present invention.

FIG. 9 is an example of a circuit constitution which constitutes a part of the source line drive circuit in the liquid crystal display device according to the fourth embodiment of the present invention.

FIG. 10 is a voltage waveform view of voltages inputted to and outputted from a source line drive circuit in the liquid crystal display device according to the fourth embodiment of the present invention.

FIG. 11 is an entire view of a conventional liquid crystal display device.

FIG. 12 is a voltage waveform diagram which indicates the relationship of signals of an input part for every horizontal cycle in a control circuit of the conventional liquid crystal display device.

FIG. 13 is a voltage waveform diagram which indicates the relationship of signals of an input part for every vertical cycle in the control circuit of the conventional liquid crystal display device.

FIG. 14 is a constitutional view of a display screen of the conventional liquid crystal display device.

FIG. 15 is a voltage waveform diagram of voltages of a source line and a gate line which are inputted to a display screen in the conventional liquid crystal display device.

### DESCRIPTION OF THE PREFERRED EMBODIMENTS

Embodiments of a liquid crystal display device according to the present invention are explained hereinafter in conjunction with attached drawings.

(First Embodiment)

In a liquid crystal display device according to the first embodiment of present invention, a display screen on which a plurality of source lines and a plurality of gate lines are arranged in a matrix array. In this first embodiment, m pieces of source lines are arranged. Further, a plurality of gate lines are divided into a plurality of blocks \mathring{1}, \mathring{2}, \mathring{3}, . . . . The block \mathring{1} includes A pieces of gate lines Y1, Y2, Y3, . . . , YA1. The block \mathring{2} includes A pieces of gate lines YA1+1, YA1+2, YA1+3, . . . , YA2. The block \mathring{3} includes A pieces of gate lines YA2+1, YA2+2, YA2+3, . . . YA3.

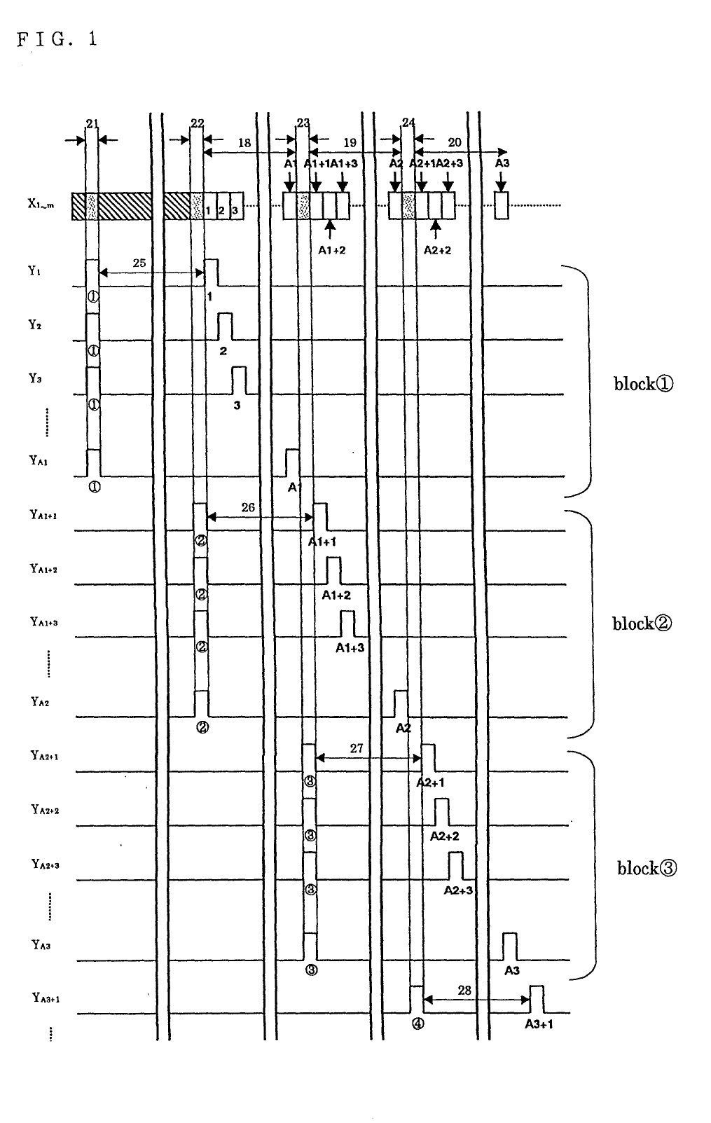

FIG. 1 is a voltage waveform diagram (timing chart) of source line voltages and gate line voltages inputted to the display screen in the liquid crystal display device according to the first embodiment of the present invention. X1 to Xm indicate image data to respective source lines X1 to Xm and Y1, Y2, Y3, . . . , YA, YA1+1, YA1+2, YA2+3, . . . , YA2, YA2+1, YA2+2, YA2+3, . . . , YA3 respectively indicate gate signals of corresponding gate lines. In FIG. 1, the abscissas indicate the same elapsed time. Symbols 18, 19, 20 respectively indicate writing periods of image data corresponding to respective blocks \mathring{1}, \mathring{2}, \mathring{3}. Symbols 21, 22, 23, 24 indicate writing periods of non-image data which respectively correspond to the blocks \mathring{1}, \mathring{2}, \mathring{3}, \mathring{4}. Different from the image data, the non-image data is data which indicates given unchanging values. Symbols 25, 26, 27, 28 indicate delay times each of which is counted from a time of completion of the writing period of the non-image data to a point of time that the writing period of the image data in the first gate lines of respective blocks \mathring{1}, \mathring{2}, \mathring{3}, \mathring{4} is started. As the first gate line of each block, the gate line Y1 is used in the block \mathring{1}, the gate line YA1+1is used in the block \mathring{2}, the gate line YA2+1is used in the block \mathring{3}, and the gate line YA3+1 is used in the block \mathring{4}. A combined period of the period indicated by the symbol 21 and the period indicated by the symbol 25, a combined period of the period indicated by the symbol 22 and the period indicated by the symbol 26, a combined period of the period indicated by the symbol 23 and the period indicated by the symbol 27 and a combined period of the period indicated by the symbol 24 and the period indicated by the symbol 28 are respectively set to times necessary for initializing liquid crystal display elements which constitute pixel cells. The suffixes A1, A2, A3 given to Y which indicates the gate lines are arbitrary values which indicate the final gate lines of respective blocks \mathring{1}, \mathring{2}, \mathring{3}. Here, as the voltage values in the writing periods 21 to 24 of the non-image data, it is effective to adopt voltage values of high level such as black display data which allows the liquid crystal display elements 14 respond most rapidly, that is, which makes the time necessary for initializing the state of the liquid crystal display elements 14 to a given state shortest or a given voltage value of a level which is higher than the black display data. Further, it is effective to set the writing periods 21 to 24 of the non-image data to 1 horizontal cycle which corresponds to a change cycle of image data signal or more than 1 horizontal cycle.

During one frame period or 1 field period, the gate lines Y1-YA1, YA1+1-YA2, YA2+1-YA3 in FIG. 1 are sequentially risen for writing the image data signals in the pixel cells in the display screen for every block, that is, the block \mathring{1}, the block \mathring{2}, the block \mathring{3}, . . . so as to provide writing effective periods 18, 19, 20 (high level H state in FIG. 1). At this point of time, among respective blocks, prior to the image data writing start position of the first gate line at the preceding block, the gate line is risen for each block to write a given non-image data signal into the pixel cell by an amount of 1 block simultaneously so as to provide the writing effective periods 21 to 24 (high level H state in FIG. 1). The source lines X1 -Xm at this point of time are provided with a memory function and a delay function to obtain the writing effective periods 21 to 24 of the non-image data signals in respective blocks such that the source lines X1-Xm can delay these times by periods corresponding to the periods 21 to 24 each time the non-image data signals are selected in respective blocks.

To be more specific, in the block \mathring{1}, for example, all gate lines Y1, Y2, Y3, . . . YA1 of the block \mathring{1} are risen simultaneously in the period 21 so that the non-image data signals from the corresponding source lines are written in all pixel cells corresponding to the block \mathring{1}. In the period 25 which follows the period 21, the voltages of respective gate lines Y1, Y2, Y3, . . . , YA1 are once lowered to the low level. In the period 18 which follows the period 25, respective gate lines Y1, Y2, Y3, . . . , YA1 are sequentially risen so that the image data signals 1, 2, . . . , A from the source lines are sequentially written in respective pixel cells corresponding to the block \mathring{1}.

With respect to the block \mathring{2}, all gate lines YA1+1, YA1+2, YA1+3, . . . YA2 of the block \mathring{2} are risen simultaneously in the period 22 so that the non-image data signals from the corresponding source lines are written in all pixel cells corresponding to the block \mathring{2}. In the period 26 which follows the period 22, the voltages of respective gate lines YA1+1,YA1+2, YA1+3, . . . YA2 are once lowered to the low level. In the period 19 which follows the period 26, respective gate lines YA1+1, YA1+2, YA1+3, . . . YA2 are sequentially risen so that the image data signals A1+1, A+2, . . . , A2 from the corresponding source lines are sequentially written in respective pixel cells corresponding to the block \mathring{2}.

With respect to the block \mathring{3}, all gate lines YA2+1, YA2+2, YA2+3, . . . YA3 of the block \mathring{3} are risen simultaneously in the period 23 so that the non-image data signals from the corresponding source lines are written in all pixel cells corresponding to the block \mathring{3}. In the period 27 which follows the period 23, the voltages of respective gate lines YA2+1, YA2+2, YA2+3, . . . YA3 are once lowered to the low level. In the period 20 which follows the period 27, respective gate lines YA2+1, YA2+2, YA2+3, . . . YA3 are sequentially risen so that the image data signals A2+1, A2+2, . . . , A3 from the corresponding source lines are sequentially written in respective pixel cells corresponding to the block \mathring{3}.

Here, the start timing of the writing period 18 of the image data signals of the block \mathring{1} coincides with the completion timing of the writing period 22 of the non-image data signals of the next block \mathring{2}. In the same manner, the start timing of the writing period 19 of the image data signals of the block \mathring{2} coincides with the completion timing of the writing period 23 of the non-image data signals of the next block \mathring{3} and the start timing of the writing period 20 of the image data signals of the block \mathring{3} coincides with the completion timing of the writing period 24 of the non-image data signals of the next block \mathring{4}.

That is, during the 1 frame period or during the 1 field period, respective gate lines supply different kinds of data signals, that is, the image data signals and the non-image data signals once for each, that is, twice in total. In the first selection, the given non-image data signals are supplied for every block at respective periods 21, 22, 23 so as to set the display elements 14 in the initialized state. Then, in the respective periods 18, 19, 20 which follow the periods 22, 23, 24 by one block, by performing the second selection, the image data signals are sequentially supplied so as to set the display elements 14 in the image data state.

In the periods 21, 22, 23, to write the non-image data signals for every fixed period, the source lines are provided with a memory function and a delay function so as to delay the non-image data signals by given periods. Here, any position maybe chosen as the delay start position for making the non-image data signals delayed by a given period each time the non-image data signals are selected. For example, when the start positions of the writing effective periods of the image data signals at respective first gate lines of respective blocks \mathring{1}, \mathring{2}, \mathring{3} coincide with the end of the periods in which non-image data signals are given, the processing which delays the writing effective period of the non-image data signals from the start position of the writing effective period of the image data signals in the block \mathring{2} and thereafter delays the writing effective period of the non-image data signals from the start position of the writing effective period of the image data signals in the block \mathring{3} is performed whereby the writing effective period of the non-image data signals can be cumulatively delayed for every block eventually.

As described above, according to the first embodiment shown in FIG. 1, prior to the writing of the image data signals in the pixel cells, given non-image data signals are added to the liquid crystal display elements 14 of respective pixel cells and hence, the initial state of the display elements 14 can be made constant so that it becomes possible to eliminate the display state dependency of an amount corresponding to the preceding frame period or the preceding field period whereby an advantageous effect that the persistence of vision or the residual image can be reduced is obtained in the moving image whose change of image is rapid.

According to first embodiment, by adding the given non-image data signals to the display elements prior to the image data signals, the initial state of the display elements can be made constant and the display state dependency by an amount corresponding to the preceding frame period or the preceding field period can be eliminated whereby an advantageous effect that the persistence of image can be reduced is obtained.

Further, in FIG. 1, even in the case that the positions of the writing effective periods of the non-image data signals for every block are set arbitrarily or in the case that the source lines have the memory function and the delay function to cumulatively delay the image data signals by an amount corresponding to a period in which the non-image data signals are selected for every block during a plurality of frame periods or during a plurality of field periods, by adding the given non-image data signals to the display elements prior to the supply of the image data signals, the initial state of the display elements can be made constant so that it becomes possible to eliminate the display state dependency of an amount corresponding to the preceding frame period or the preceding field period whereby an advantageous effect that the persistence of vision or the residual image can be reduced is obtained.

(Second Embodiment)

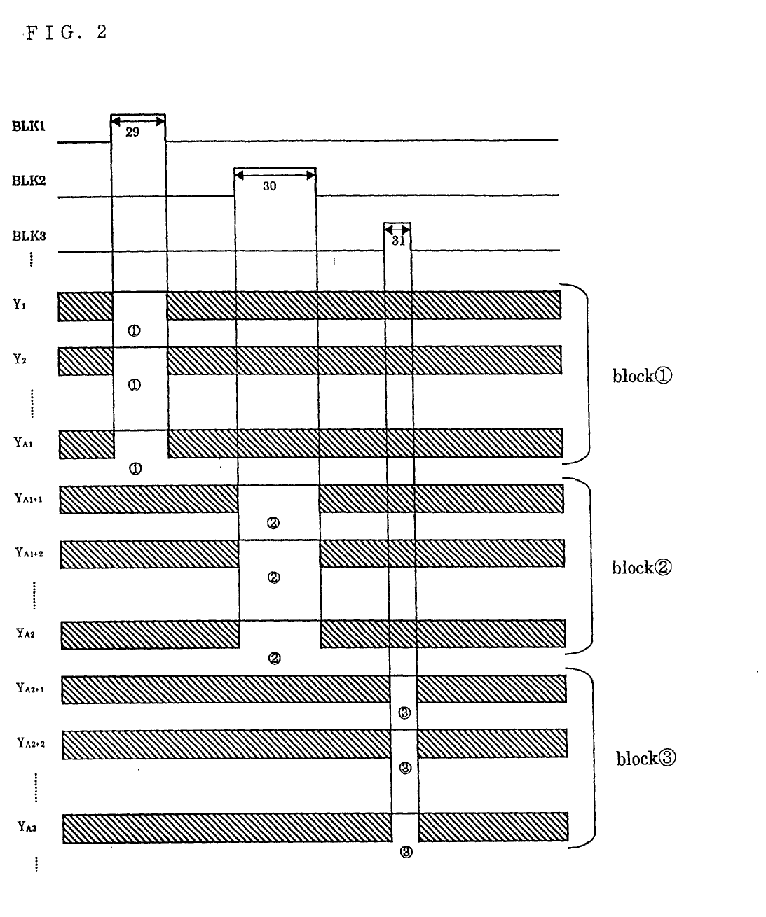

FIG. 2 is a voltage waveform diagram (timing chart) of voltages inputted to or outputted from a gate line drive circuit incorporated in a liquid crystal display device according to the second embodiment of the present invention. In the drawing, the abscissas indicate the elapsed time. In FIG. 2, BLK1, BLK2, BLK3, . . . indicate control signals which are inputted to the gate line drive circuit and control the ON state of respective gate lines for every block \mathring{1}, \mathring{2}, \mathring{3} . . . , Y1, Y2, . . . , YA1, YA1+1, YA1+2, . . . YA2, YA2+1, YA2+2, . . . , YA3 indicate respective gate line signals outputted from the gate line drive circuit, and symbols, 29, 30, 31 indicate periods for obtaining the ON state (high level H state in the drawing) for respective blocks \mathring{1}, \mathring{2}, \mathring{3}, . . . . Here, the control signals BLK1, BLK2, BLK3, . . . perform the same operation even when their polarity is reversed from the polarity shown in the drawing. The delay times from inputs to outputs are omitted in the drawing. In the drawing, hatched portions of Y1, Y2, . . . , YA1, YA1+1, YA1+2, . . . , YA2, YA2+1, YA2+2, . . . , YA3 mean operation periods which are not dependent on the control signals BLK1, BLK2, BLK3, . . . .

In the periods 29, 30, 31, the input signals BLK1, BLK2, BLK3, . . . in FIG. 2 set the gate line signals Y1-YA1, YA1+1-YA2, YA2+1-YA3, . . . which constitute outputs to the high level H state (ON state) for respective blocks which correspond to the periods 29, 30, 31, that is, for every block \mathring{1}, block \mathring{2}, block \mathring{3}, . . . .

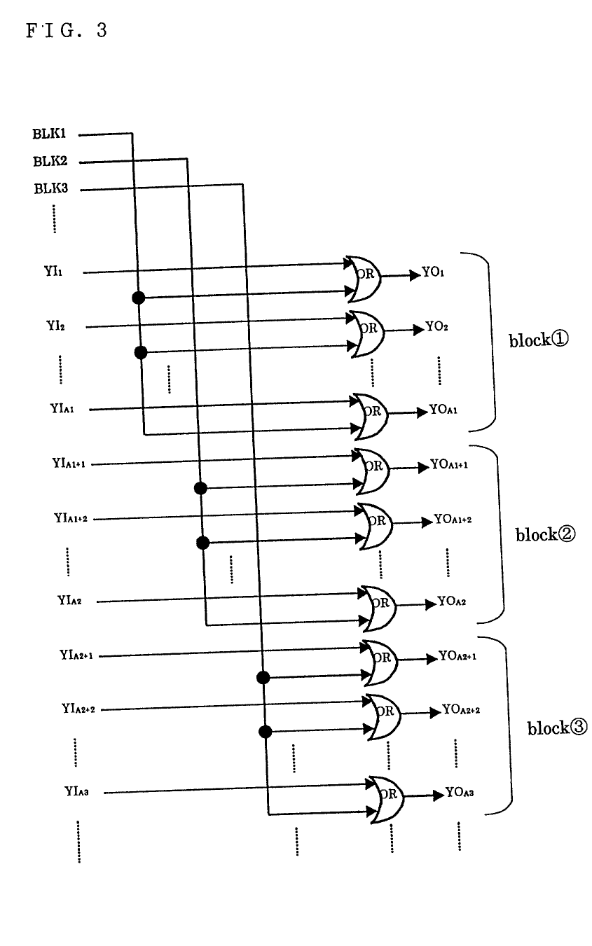

FIG. 3 is a view of a constitutional example of circuit which constitutes a portion of the gate line drive circuit for realizing the functions shown in FIG. 2. By connecting the constitution shown in FIG. 3 to a rear stage of the digital circuit constitutional part having the conventional operations, it becomes possible to obtain the functions shown in FIG. 2. In FIG. 3, BLK1, BLK2, BLK3, . . . indicate input signals which control the ON state of respective gate lines for every block \mathring{1}, \mathring{2}, \mathring{3} . . . , YI1-YIA1, YIA1+1-YIA2, YIA2+1-YIA3, . . . indicate gate line input signals, and YO1-YOA1, YOA1+1-YOA2, YOA2+1-YOA3, . . . indicate gate line output signals. In the operation of this circuit, with the use of OR circuits to which the input signals BLK1, BLK2, BLK3, . . . are inputted, the high level H state (ON state) can be selected for every block \mathring{1},\mathring{2}, \mathring{3} . . . .

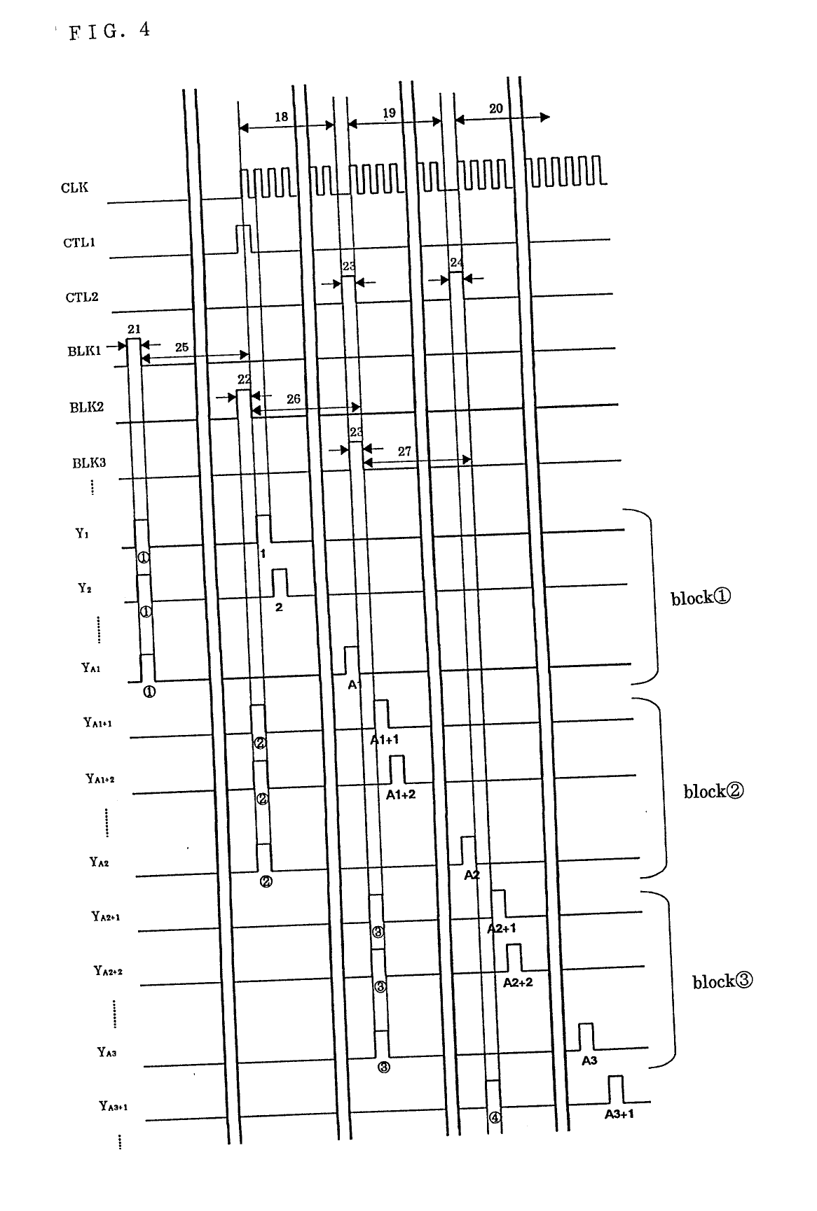

FIG. 4 is a voltage waveform diagram (timing chart) of voltages inputted to or outputted from the gate line drive circuit incorporated in the liquid crystal display device according to the second embodiment of the present invention. In the drawing, the abscissas indicate the elapsed time. In FIG. 4, CLK indicates vertical clock signals which are inputted to the gate line drive circuit, CTL1 indicates a vertical start signal which is inputted to the gate line drive circuit, CTL2 indicates signals which are inputted to the gate line drive circuit and control the OFF state, BLK1, BLK2, BLK3 . . . indicate signals which are inputted to the gate line drive circuit and control the ON state of respective gate lines for every block \mathring{1}, \mathring{2}, \mathring{3}, Y1, Y2, Y3 . . . indicates gate line signals which are outputted from the gate line drive circuit, numerals 18, 19, 20 indicate periods for sequentially performing the shifting operation from the first gate line to the last gate line in respective blocks \mathring{1}, \mathring{2}, \mathring{3} numerals 21, 22, 23, 24 indicate periods for obtaining the ON state for every block \mathring{1}, \mathring{2}, \mathring{3} . . . and numerals 25, 26, 27 indicate periods from a point of time that the pixel cells are initialized to given values to a point of time that the writing of image data signals to the first gate line is started for every block \mathring{1},\mathring{2}, \mathring{3} . . . Here, the signals BLK1, BLK2, BLK3, . . . perform the same operation even when their polarity is reversed from the polarity shown in the drawing. The delay times from inputs to outputs are omitted in the drawing.

In FIG. 4, first of all, with respect to the block \mathring{1} of the gate line, in the period 21 indicated in reference to the signal BLK1, the non-image data signals of a given value are written in the pixel cells in the gate lines in the block \mathring{1} and respective pixel cells which correspond to the block \mathring{1} are initialized. This initialization is completed during the period 25 which follows the period 21. During the period 26 which follows the period 25, the image data signals are written in the pixel cells in the gate lines sequentially from the first gate line Y1.

Subsequently, with respect to the block \mathring{2}, during the period 22 indicated in reference to the signal BLK2, that is, during the period 22 immediately before the period 26, the non-image data signals of a given value are written in the respective pixel cells of the block \mathring{2} and the respective pixel cells of the block \mathring{2} are initialized. This initialization is completed during the period 26. During the period 27 which follows the period 26, the image data signals are written in the pixel cells sequentially from the first gate line YA1+1.

With respect to other blocks . . . , that is, block \mathring{3} and blocks which follow the block \mathring{3}, the image data signals are written after initialization as in the case of the above-mentioned block \mathring{2}. Further, the gate lines YA1, YA2, YA3, . . . which correspond to the final gate lines of respective blocks \mathring{1}, \mathring{2}, \mathring{3} are forcedly set to the low level L state during the periods 23, 24 indicated by the signal CTL2 to prevent the gate lines YA1, YA2, YA3, . . . from becoming the high level H state during the periods 23, 24 due to the sequential shifting operation by the edge of the signal CLK.

Accordingly, in FIG. 4, prior to the writing of the image data signals in the pixel cells, the given non-image data signals are added to the liquid crystal display elements 14 of respective pixel cells and hence, the initial state of the display elements can be made constant so that it becomes possible to eliminate the display state dependency of an amount corresponding to the preceding frame period or the preceding field period whereby an advantageous effect that the persistence of vision or the residual image can be reduced is obtained with respect to the moving image whose change of image is rapid.

According to the second embodiment, at the time of outputting the voltages which set the switching elements in the display screen to the ON state from a plurality of output terminals during the one frame period or during the 1 field period, the gate line drive circuit having the selection function for each block as a unit is used and hence, the persistence of vision can be reduced and the high-quality display device can be obtained.

(Third Embodiment)

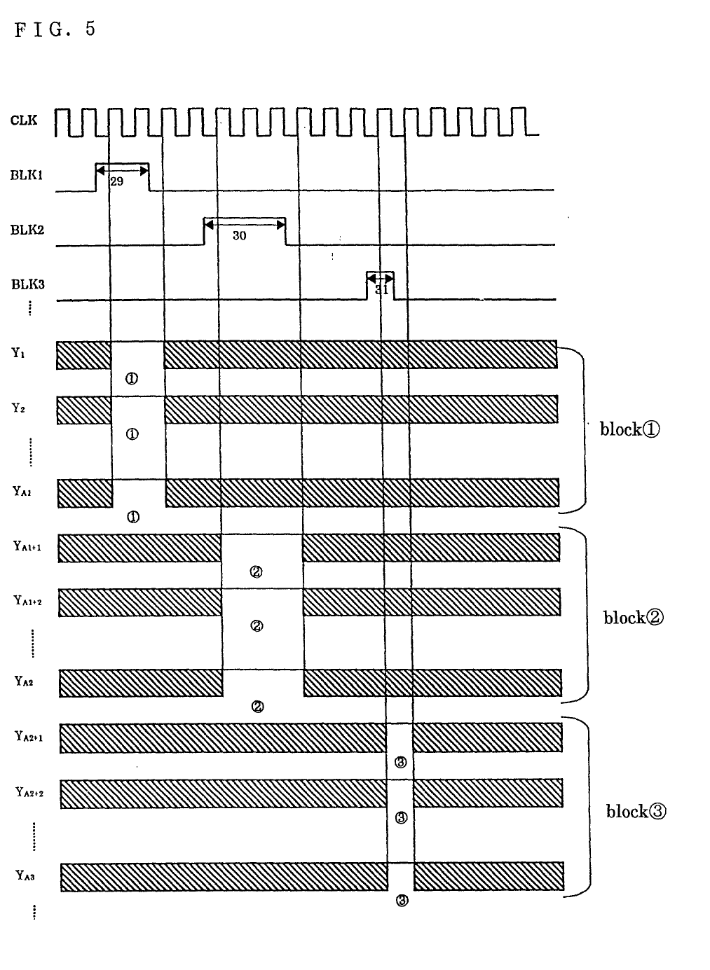

FIG. 5 is a voltage waveform diagram (timing chart) of voltages inputted to or outputted from a gate line drive circuit incorporated in a liquid crystal display device according to the third embodiment of the present invention. In the drawing, the abscissas indicate the elapsed time. In FIG. 5, CLK indicates vertical clock signals which are inputted to the gate line drive circuit, BLK1, BLK2, BLK3, . . . indicate signals which are inputted to the gate line drive circuit and control the ON state of respective gate lines for every block \mathring{1}, \mathring{2}, \mathring{3}. . . , Y1, Y2, . . . , YA1, YA1+1, YA1+2, . . . , YA2, YA2+1, YA2+2, . . . , YA3, . . . indicate gate line signals outputted from the gate line drive circuit, and symbols 29, 30, 31 indicate periods for obtaining the ON state (high level H state in the drawing) for respective blocks \mathring{1}, \mathring{2}, \mathring{3}, . . . . Here, the signals BLK1, BLK2, BLK3, . . . perform the same operation even when their polarity is reversed from the polarity shown in the drawing. The delay times from inputs to outputs are omitted in the drawing. In the drawing, hatched portions of Y1, Y2, . . . , YA1, YA1+1, YA1+2, . . . , YA2, YA2+1, YA2+2, . . . , YA3 mean operation periods which are not dependent on the control signals BLK1, BLK2, BLK3, . . . .

In the periods 29, 30, 31, the input signals BLK1, BLK2, BLK3, . . . in FIG. 5 set the gate line signals Y1-YA1, YA1+1-YA2, YA2+1-YA3, . . . which constitute outputs to the high level H state (ON state) for respective blocks \mathring{1}, \mathring{2}, \mathring{3}, which correspond to the periods 29, 30, 31, that is, for every block \mathring{1}, block \mathring{2}, block \mathring{3}, . . . . The difference between FIG. 5 and FIG. 2 lies in that, the periods 29, 30, 31 are set in response to the signals BLK1, BLK2, BLK3, . . . which control the ON state without being in synchronism with the vertical clock signals in FIG. 2, while the periods 29, 30, 31 are set in response to the signals which control the ON state in synchronism with the vertical clock signals in FIG. 5. Other operations are substantially equal to those shown in FIG. 2.

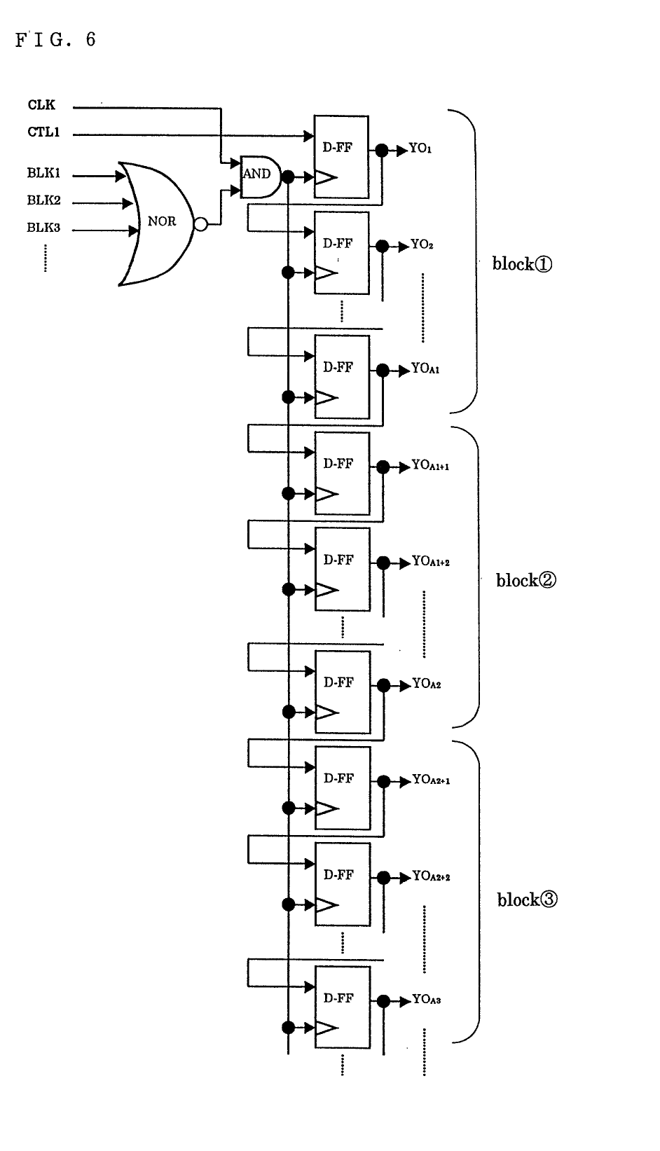

FIG. 6 is a circuit constitutional view of a portion of the gate line drive circuit for realizing the functions shown in FIG. 5. As shown in the drawing, by connecting the circuit shown in FIG. 6 to a rear stage of the digital circuit constitutional part having the conventional operations, it becomes possible to obtain the functions shown in FIG. 5. In FIG. 6, BLK1, BLK2, BLK3, . . . indicate input signals which control the ON state of respective gate lines for every block \mathring{1}, \mathring{2}, \mathring{3} . . . , YI1-YIA1, YIA1+1-YIA2, YIA2+1-YIA3, . . . indicate gate line input signals, and YO1-YOA1, YOA1+1-YOA2, YOA2+1-YOA3, . . . indicate gate line output signals. In the operation of this circuit, with the use of OR circuits to which the input signals BLK1, BLK2, BLK3, . . . are inputted, the high level H state (ON state) can be selected for every block \mathring{1}, \mathring{2}, \mathring{3} . . . . Further, the third embodiment differs from the second embodiment in that, as the signal BLK1, BLK2, BLK3, . . . , signals obtained by performing the simultaneous processing on the vertical clock signals are used.

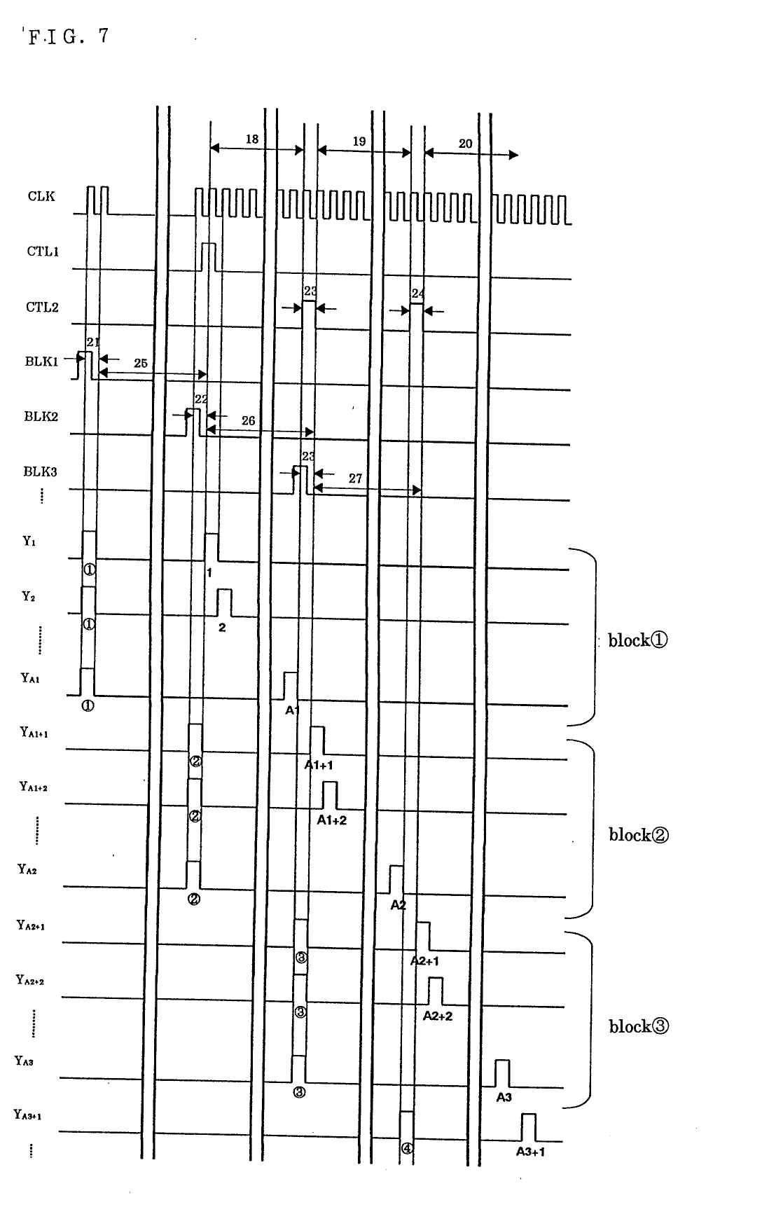

FIG. 7 is a voltage waveform diagram (timing chart) of voltages inputted to or outputted from the gate line drive circuit incorporated in the liquid crystal display device according to the third embodiment of the present invention. In the drawing, the abscissas indicate the elapsed time. In FIG. 7, CLK indicates vertical clock signals which are inputted to the gate line drive circuit, CTL1 indicates a vertical start signal which is inputted to the gate line drive circuit, CTL2 indicates signals which are inputted to the gate line drive circuit and control the OFF state, BLK1, BLK2, BLK3 . . . indicate signals which are inputted to the gate line drive circuit and control the ON state of respective gate lines for every block \mathring{1},\mathring{2},\mathring{3}, Y1, Y2, . . . , YA, YA1+1, YA1+2, . . . , YA2, YA2+1, YA2+2, . . . , YA3, . . . indicate gate line signals which are outputted from the gate line drive circuit, numerals 18, 19, 20 indicate periods for sequentially performing the shifting operation from the first gate line Y1, YA1+1, YA2+1, . . . to the last gate lines YA1, YA2, YA3 in respective blocks \mathring{1}, \mathring{2},\mathring{3}, numerals 21, 22, 23, 24 indicate periods for obtaining the ON state for every block \mathring{1}, \mathring{2}, \mathring{3} . . . and numerals 25, 26, 27 indicate periods from a point of time that the pixel cells are initialized to given values to a point of time that the writing of image data signals to the first gate lines Y1, YA1+1, YA2+1, . . . is started for every block \mathring{1},\mathring{2}, \mathring{3} . . . . Here, the control signals BLK1, BLK2, BLK3, . . . perform the same operation even when their polarity is reversed from the polarity shown in the drawing. The delay times from inputs to outputs are omitted in the drawing.

FIG. 6 shows a circuit constitutional example which constitutes a part of the gate line drive circuit for facilitating the realization of the functions shown in FIG. 7. In the drawing, by replacing the digital circuit constitutional part having the conventional sequential shifting operation with the constitution shown in FIG. 6, it becomes possible to obtain the functions shown in FIG. 7. In FIG. 6, CLK indicates vertical clock signals which are inputted to the gate line drive circuit, CTL1 indicates a vertical start signal which is inputted to the gate line drive circuit, BLK1, BLK2, BLK3 . . . indicate input signals which control the ON state for every block \mathring{1}, \mathring{2}, \mathring{3}, YO1-YOA1, YOA1+1-YOA2, YOA2+1-YOA3, . . . indicate gate line output signals. In the operation of the circuit, by using a NOR circuit to which the signals BLK1, BLK2, BLK3 . . . are inputted, a control signal for masking the signal CLK is obtained and by masking the generated control signal and the signal CLK with an AND circuit, a signal equal to the signal CLK shown in FIG. 4 can be obtained. During the period in which the signals BLK1, BLK2, BLK3 . . . are synchronized in clock in the high level H state, the sequential shifting operation is not performed.

In FIG. 7, first of all, with respect to the block \mathring{1}, in the period 21, the non-image data signals of a given value are written in the pixel cells in the gate lines in the block \mathring{1} and respective pixel cells of the block \mathring{1} are initialized. This initialization is completed during the period 25 which follows the period 21. During the period 26 which follows the period 25, the image data signals are written in the pixel cells sequentially from the first gate line Y1 to the last gate line YA1.

Subsequently, with respect to the block \mathring{2}, during the period 22 immediately before the period 26 starts, the non-image data signals of a given value are written in the respective pixel cells of the block \mathring{2} and the respective pixel cells of the block \mathring{2} are initialized. This initialization is completed during the period 26. During the period 27 which follows the period 26, the image data signals are written in the pixel cells sequentially from the first gate line YA1+1to the last gate line YA2. Also with respect to the block \mathring{3} and other blocks which follow the block \mathring{3}, the image data signals are written after initializing the corresponding pixel cells as in the case of the above-mentioned blocks \mathring{1}, \mathring{2}. Further, the gate lines YA1, YA2, YA3, . . . which correspond to the final gate lines of respective blocks \mathring{1}, \mathring{2}, \mathring{3} are forcedly set to the low level L state during the periods 23, 24 indicated by the signal CTL2 to prevent the gate lines YA1, YA2, YA3, . . . from becoming the high level H state during the periods 23, 24 due to the sequential shifting operation by the edge of the signal CLK. Different from the case shown in FIG. 4, since the clock of the signal CLK is present even during the periods 23, 24 in the case shown in FIG. 7, the sequential shifting operation is not performed during the periods 23, 24 in which the signals BLK1, BLK2, BLK3 . . . are synchronized in clock in the high level H state.

Accordingly, in FIG. 7, prior to the writing of the image data signals in the pixel cells, the non-image data signals of a given value are added to the liquid crystal display elements of respective pixel cells and hence, the initial state of the display elements can be made constant so that it becomes possible to eliminate the display state dependency of an amount corresponding to the preceding frame period or the preceding field period whereby an advantageous effect that the persistence of vision or the residual image can be reduced is obtained in the moving image whose change of image is rapid.

According to the third embodiment, at the time of outputting the voltages which set the switching elements in the display screen to the ON state from a plurality of output terminals during the 1 frame period or during the 1 field period, the gate line drive circuit having the selection function for each block as a unit is used and hence, the persistence of vision or the residual image can be reduced and the high-quality display device can be obtained.

(Fourth Embodiment)

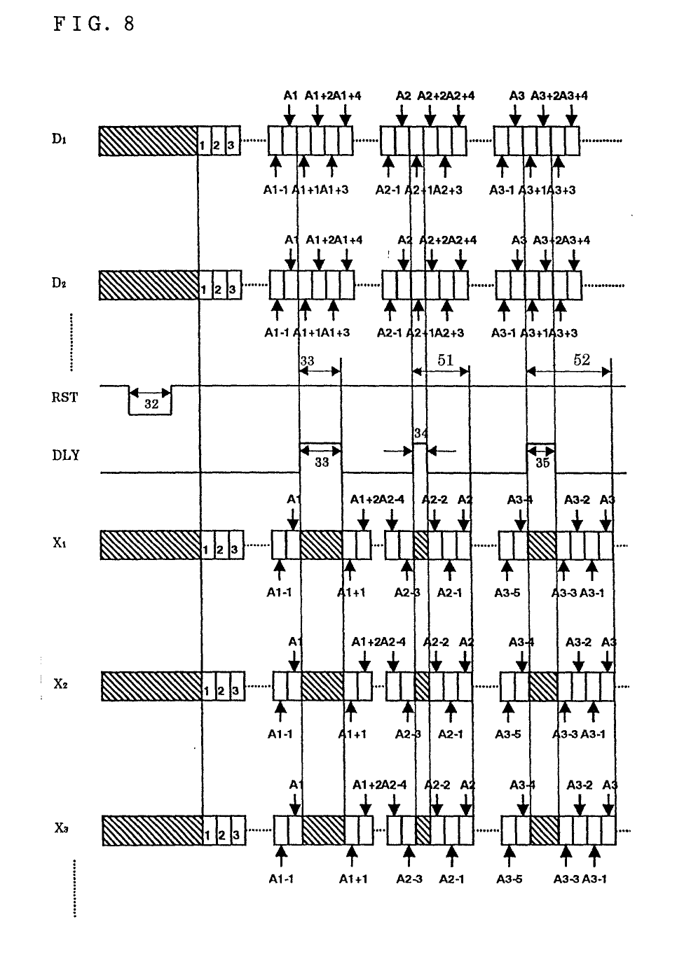

FIG. 8 is a voltage waveform diagram (timing chart) of voltages inputted to or outputted from a source line drive circuit incorporated in a liquid crystal display device according to the fourth embodiment of the present invention. In the drawing, the abscissas indicate the elapsed time. In FIG. 8, D1, D2, . . . indicate image data signals which are inputted to the source line drive circuit, RST indicates a signal which is inputted to the source line drive circuit and controls the initialization (resetting) of a delay amount of image data, DLY indicate signals which are inputted to the source line drive circuit and control the delay amount of image data signals, X1, X2, X3, . . . indicate respective source line signals which are outputted from the source line drive circuit, numeral 32 indicates a period (low level L in the drawing) of initializing the delay amount of the image data, numeral 33, 34, 35 indicate periods for obtaining the delay amount of the image data signals (high level H state in the drawing). Here, the signals DLY, RST perform the same operation even when their polarity is reversed from the polarity shown in the drawing. The delay times from inputs to outputs are omitted in the drawing. In the drawing, hatched portions of X1, X2, X3 . . . mean operation periods which are not dependent on the signal D1, D2, . . . , the signal RST and the signal DLY.

The input signal RST in FIG. 8 initializes a cumulative delay amount which has been cumulated during the period 32. The input signal DLY in FIG. 8 performs the cumulative delay of the outputs X1, X2, X3, . . . amounting to times which respectively correspond to the period 33, a combined period 51 of the period 33 and the period 34 and a combined period 52 of the period 33, the period 34 and the period 35 for every period 33, 34, 35.

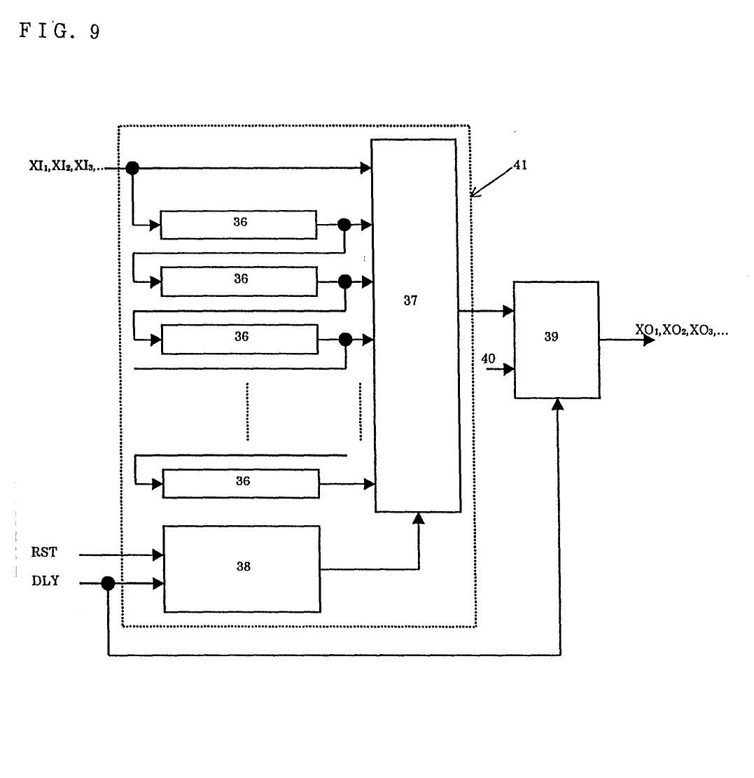

FIG. 9 is a circuit constitutional example of a part of the source line drive circuit for realizing the functions shown in FIG. 8. By inserting the constitution shown in FIG. 9 into a digital circuit constitutional part having conventional operations, the functions shown in FIG. 8 can be obtained. In FIG. 9, RST indicates a signal which is inputted to the source line drive circuit and controls the initialization (resetting) of a delay amount of image data signals, DLY indicates a signal which is inputted to the source line drive circuit and controls the delay amount of image data, XI1, XI2, XI3, . . . indicate source line input signals, XO1, XO2, XO3, . . . indicate source line output signals, numeral 36 indicates a circuit which delays and stores the image data signals of an amount corresponding to 1 horizontal cycle, the multiple of the 1 horizontal cycle or a fixed period, numeral 37 indicates a selection circuit for obtaining a cumulative delay amount of the image data signals, numeral 38 indicates a counter which counts the cumulative delay value of the image data signals, numeral 39 indicates a selection circuit between image data signals and non-image data signals, numeral 40 indicates non-image data signals having a given value, and numeral 41 indicates a cumulative delay function block of image data signals.

With respect to the manner of operation of the circuit, with the use of the delay/memory circuit 36 to which the signals XI1, XI2, XI3, . . . are inputted, a plurality of image data signals which are cumulatively delayed by an amount corresponding to 1 horizontal cycle, the multiple of the 1 horizontal cycle or the fixed period are obtained. Using the counter 38, the initialization is performed with the signal RST so that a value which counts the high level H period of the signal DLY is obtained. Using a counted value from the counter 38 as a selection signal, by inputting a plurality of the above-mentioned delayed image data signals, the image data signals which are cumulatively delayed by an amount corresponding to the high level H period of the signal DLY are obtained by the selection circuit 37. With the use of the selection circuit 39 to which the generated image data signals and the non-image data signals 40 are inputted, the image data signals are obtained such that the writing of the non-image data having a given value is performed during the high level H period of the signal DLY and the writing of the image data signal is performed during the other period. Further, in FIG. 9, even when XI1, XI2, XI3, . . . are assumed as the image data input signals DI1, DI2, DI3, . . . and XO1, XO2, XO3, . . . are assumed as the image data output signals DO1, DO2, DO3, . . . , by inserting the constitution shown in FIG. 9 into a digital circuit constitutional part having the conventional operations, the functions shown in FIG. 8 can be obtained.

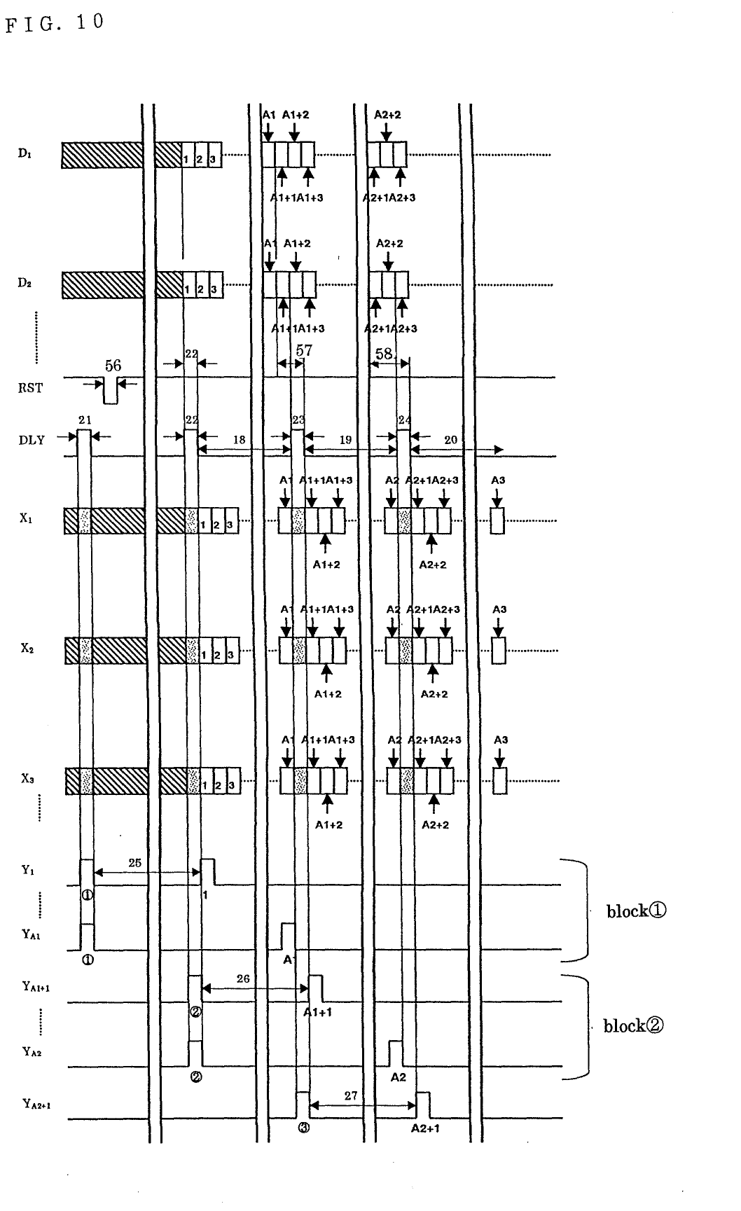

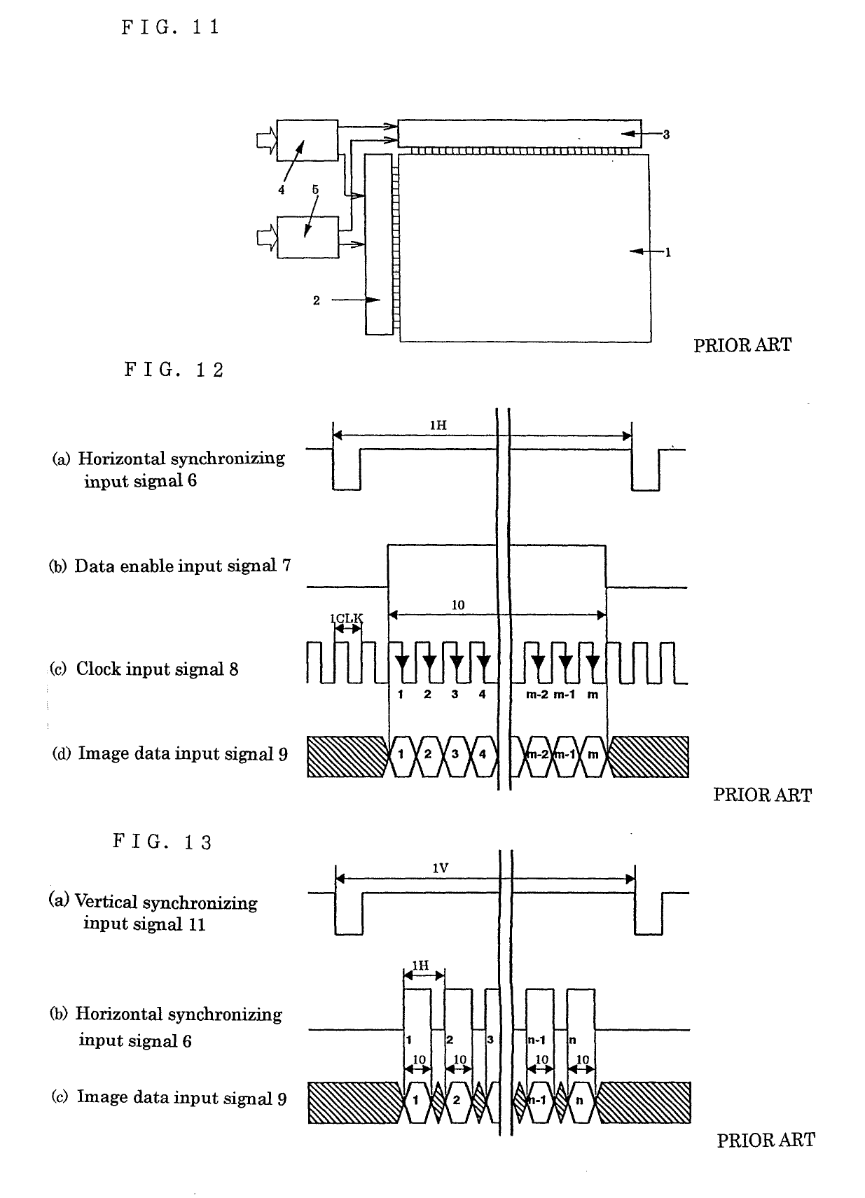

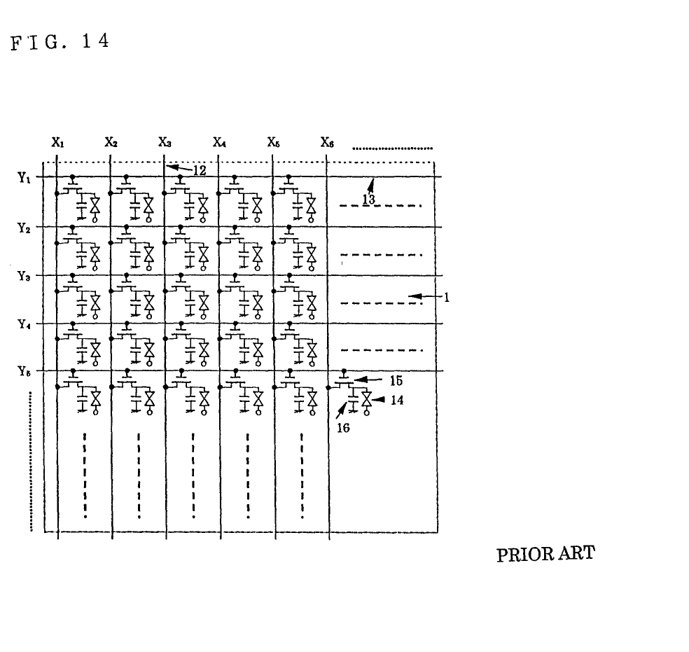

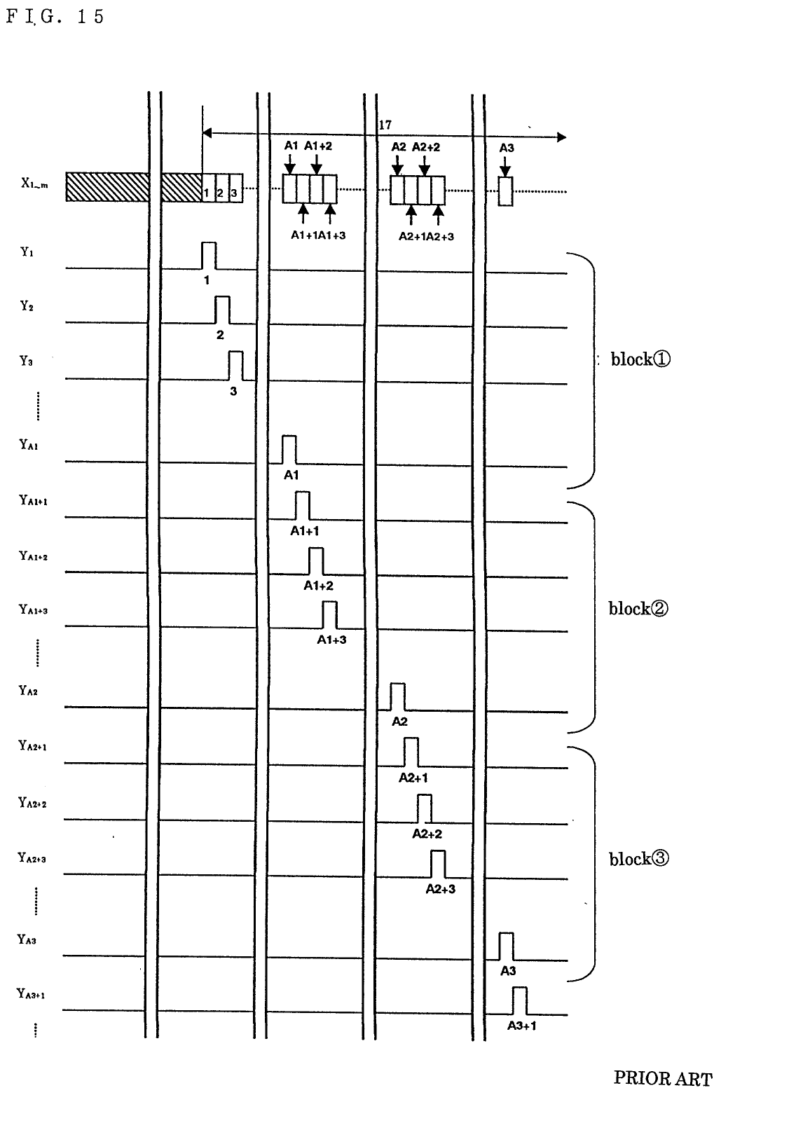

FIG. 10 is a voltage waveform diagram (timing chart) of voltages inputted to or outputted from a source line drive circuit incorporated in a liquid crystal display device according to the fourth embodiment of the present invention. In the drawing, the abscissas indicate the elapsed time. In FIG. 10, D1, D2, . . . indicate image data signals which are inputted to the source line drive circuit, RST indicates a signal which is inputted to the source line drive circuit and controls the initialization (resetting) of a delay amount of image data, DLY indicate signals which are inputted to the source line drive circuit and control the delay amount of image data signals, X1, X2, X3, . . . indicate respective source line signals which are outputted from the source line drive circuit, numerals 18, 19, 20 indicate image data writing periods which correspond to respective gate lines from the first gate lines Y1, YA1+1, . . . to the last gate lines YA, YA2 in respective blocks \mathring{1}, \mathring{2}, \mathring{3} of, numerals 21, 22, 23, 24 indicate periods for controlling the cumulative delay amount of the image data and for obtaining given values for every block, and numerals 25, 26, 27 indicate periods from a point of time that the pixel cells are initialized to given values to a point of time that the writing of image data signals to the first gate line is started for every block \mathring{1}, \mathring{2}, \mathring{3} . . . , and numeral 56 indicates a period in which a cumulative delay amount in the image data is initialized. Here, the signals RST, DLY perform the same operation even when their polarity is reversed from the polarity shown in the drawing. The delay times from inputs to outputs are omitted in the drawing. Here, the block interval corresponds to those shown in FIG. 1.

In FIG. 10, first of all, with respect to the block \mathring{1}; of the gate line, in the period 21 indicated in reference to the signal DLY, the non-image data signals of a given value for the block \mathring{1} are obtained and simultaneously are written in the pixel cells in response to the gate line signal and respective pixel cells of the block \mathring{1} are initialized. This initialization is completed during the period 25 which follows the period 21. During the period 26 which follows the period 25, the image data signals are sequentially obtained and is simultaneously written in the pixel cells in response to the gate line signal from the first gate line Y1 to the last gate line YA1.

Subsequently, with respect to the block \mathring{2}, during the period 22 immediately before the period 26 starts, that is, during the period 22 which is indicated in reference to the signal DLY, the non-image data signals of a given value for the block \mathring{2} are obtained and are simultaneously written in the pixel cells in response to the gate line signal and the respective pixel cells of the block \mathring{2} are initialized. This initialization is completed during the period 26 which follows the period 22. During the period 27 which follows the period 26, the image data signals are sequentially obtained and are simultaneously written in the pixel cells in response to the gate line signal from the first gate line YA1+1 to the last gate line YA2. The same processing is performed with respect to the block \mathring{3} and blocks which follow the block \mathring{3}.

In FIG. 10, the image data signals A1+1, A1+2, A1+3, . . . in the signals X1, X2, X3, . . . are more delayed than the image data signals A1+1, A1+2, A1+3, . . . in the signals D1, D2, D3, . . . by a combined period 57 of the period 22 and the period 23. In the same manner, the image data signals A2+1, A2+2, A2+3, . . . in the signals X1, X2, X3, . . . are more delayed than the image data signals A2+1, A2+2, A2+3, . . . in the signals D1, D2, . . . by a combined period 58 of the period 22, the period 23 and the period 24.

Accordingly, in FIG. 10, prior to the writing of the image data signals in the pixel cells, the non-image data signals having a given value are added to the liquid crystal display elements of respective pixel cells and hence, the initial state of the display elements can be made constant so that it becomes possible to eliminate the display state dependency of an amount corresponding to the preceding frame period or the preceding field period whereby an advantageous effect that the persistence of vision or the residual image can be reduced is obtained in the moving image whose change of image is rapid.

According to the fourth embodiment, at the time of outputting the necessary image data voltages to the switching elements in the display screen from a plurality of output terminals during the 1 frame period or during 1 field period, the source line drive circuit having the memory function and the delay function which cumulatively delays the image data signals by an amount corresponding to the 1 horizontal cycle, the multiple of 1 horizontal cycle or the fixed period is used and hence, the persistence of vision can be reduced and the high-quality display device can be obtained.

As has been described heretofore, according to the liquid crystal display device of the present invention, a plurality of gate lines are divided into a plurality of gate line blocks, in respective gate line blocks, prior to the image data writing operation for sequentially selecting the respective gate lines for the image display and for supplying image data signals corresponding to the respective gate lines to corresponding respective source lines, the non-image data writing operation for selecting all gate lines of the gate line block and for simultaneously supplying non-image data signals to corresponding respective source lines is performed.

In this manner, according to the liquid crystal display device of the present invention, it becomes possible to make the initial state of display elements of respective pixel cells constant so that the display state dependency by an amount corresponding to the preceding frame period or the preceding field period can be eliminated whereby an advantageous effect that the persistence of vision can be reduced can be obtained.

Further, according to the liquid crystal display device of the present invention, a plurality of the gate lines are divided into a plurality of gate line blocks, respective gate line blocks are provided with corresponding gate line drive circuits, each gate line drive circuit includes drive elements which drive respective gate lines in the corresponding gate line block, the respective drive elements of the gate line drive circuit which corresponds to each gate line block are controlled such that the drive elements simultaneously and preliminarily drive the corresponding gate lines prior to the driving thereof for supplying image video signals to the corresponding gate lines.

In this manner, according to the liquid crystal display device of the present invention, prior to the driving of the gate line drive circuit for supplying the image data signals, all gate lines in each gate line block are simultaneously and preliminarily driven, the persistence of image can be reduced by this preceding driving and the high-quality display device can be obtained.

Still further, according to the liquid crystal display device of the present invention, a plurality of gate lines are divided into a plurality of gate line blocks, the source lines which correspond to each gate line block are provided with the source line drive circuit, the source line drive circuit is constituted such that the line drive circuit sequentially supplies image data signals corresponding to respective gate line blocks, and respective data signals which correspond to each gate line block are sequentially cumulatively delayed by a given period.

In this manner, according to the liquid crystal display device of the present invention, the source line drive circuit is constituted such that the drive circuit sequentially supplies the image data signals corresponding to respective gate line blocks and the respective image data signals corresponding to each gate line block are sequentially cumulatively delayed by an amount corresponding to each gate block and hence, the persistence of image can be reduced whereby the high-quality display device can be obtained.

What is claimed is

1. A liquid crystal display device comprising a plurality of gate lines, a plurality of source lines which intersect a plurality of said respective gate lines, and a plurality of pixel cells which are arranged in a matrix array corresponding to intersecting points of said gate lines and said source lines,
the improvement being characterized in that a plurality of said gate lines are divided into a plurality of gate line blocks, in said respective gate line blocks, prior to an image data writing operation for sequentially selecting said respective gate lines for an image display and for supplying image data signals corresponding to said respective gate lines to corresponding respective source lines, a non-image data writing operation for selecting all gate lines of said gate line block and for simultaneously supplying non-image data signals to corresponding respective source lines is performed.

2. A liquid crystal display device according to claim 1, wherein, in a signal processing of respective source lines corresponding to a plurality of said respective gate line blocks, said image data signals are sequentially supplied corresponding to said respective gate line blocks, and respective image data signals corresponding to said each gate line block are sequentially cumulatively delayed by an amount corresponding to a period of said non-image data signals for every corresponding gate line block during one frame period.

3. A liquid crystal display device according to claim 1, wherein, in a signal processing of respective source lines corresponding to a plurality of said respective gate line blocks, said image data signals are sequentially supplied corresponding to said respective gate line blocks, and respective image data signals corresponding to said each gate line block are sequentially cumulatively delayed by an amount corresponding to a period of said non-image data signals for every corresponding gate line block during one field period.

4. A liquid crystal display device according to claim 1, wherein, in a signal processing of respective gate lines corresponding to a plurality of said respective gate line blocks, immediately before performing said image data writing operation with respect to said preceding gate line block, said non-image data writing operation is performed with respect to said succeeding gate line block.

5. A liquid crystal display device according to claim 4, wherein, in a signal processing of respective source lines corresponding to a plurality of said respective gate line blocks, said image data signals are sequentially supplied corresponding to said respective gate line blocks, and respective image data signals corresponding to said each gate line block are sequentially cumulatively delayed by an amount corresponding to a period of said non-image data signals for every corresponding gate line block during one frame period.

6. A liquid crystal display device according to claim 4, wherein, in a signal processing of respective source lines corresponding to a plurality of said respective gate line blocks, said image data signals are sequentially supplied corresponding to said respective gate line blocks, and respective image data signals corresponding to said each gate line block are sequentially cumulatively delayed by an amount corresponding to a period of said non-image data signals for every corresponding gate line block during one field period.

7. A liquid crystal display device according to claim 1, wherein, in a signal processing of said respective source lines corresponding to a plurality of said gate line blocks, said image data signals are sequentially supplied corresponding to said respective gate line blocks, and respective image data signals corresponding to said each gate line block are sequentially cumulatively delayed by an amount corresponding to a period of said non-image data signals for every corresponding gate line block during a plurality of frame periods.

8. A liquid crystal display device according to claim 1, wherein, in a signal processing of said respective source lines corresponding to a plurality of said gate line blocks, said image data signals are sequentially supplied corresponding to said respective gate line blocks, and respective image data signals corresponding to said each gate line block are sequentially cumulatively delayed by an amount corresponding to a period of said non-image data signals for every corresponding gate line block during a plurality of field periods.

9. A liquid crystal display device comprising a plurality of gate lines, a plurality of source lines which intersect a plurality of said respective gate lines, and a plurality of pixel cells which are arranged in a matrix array corresponding to intersecting points of said gate lines and said source lines,
the improvement being characterized in that a plurality of said gate lines are divided into a plurality of gate line blocks, said respective gate line blocks are provided with corresponding gate line drive circuits, said each gate line drive circuit includes drive elements which drive respective gate lines in said corresponding gate line block, said respective drive elements of said gate line drive circuit which corresponds to said each gate line block are controlled such that said drive elements simultaneously and preliminarily drive said corresponding gate lines prior to driving thereof for supplying image video signals to said corresponding gate lines.

10. A liquid crystal display device comprising a plurality of gate lines, a plurality of source lines which intersect a plurality of said respective gate lines, and a plurality of pixel cells which are arranged in a matrix array corresponding to intersecting points of said gate lines and said source lines,
the improvement being characterized in that a plurality of said gate lines are divided into a plurality of gate line blocks, said source lines which correspond to said each gate line block are provided with a source line drive circuit, said source line drive circuit is constituted such that said source line drive circuit sequentially supplies image data signals corresponding to said each gate line block, and respective image data signals which correspond to said each gate line block are sequentially cumulatively delayed by a given period.
